(19) United States
(12) Patent Application Publication
(10) Pub. No.: US 2010/0136335 A1
(43) Pub. Date: Jun. 3, 2010

(54) COMPOSITIONS AND METHODS FOR TREATING TEXTILE FIBERS

(76) Inventors: Ralph R. Sargent, Rome, GA (US); Michael S. Williams, Rome, GA (US); Michael Grigat, Rome, GA (US); Billy Lee Hullender, Tunnel Hill, GA (US)

Correspondence Address: JOHN S. PRATT, ESQ;KILPATRICK STOCKTON, LLP, 1100 PEACHTREE STREET, SUITE 2800, ATLANTA, GA, 30309, US

(21) Appl. No.: 12/571,507

(22) Filed: Oct. 1, 2009

Related U.S. Application Data
(60) Provisional application No. 61/102,233, filed on Oct. 2, 2008.

(51) Int. Cl. C09B 67/14; D02G 3/00

(52) U.S. Cl. 428/396; 8/615; 8/543; 8/552; 8/585; 8/557

(57) ABSTRACT

The present invention relates to compositions and methods for treating textile fibers and, in particular, to compositions and methods for treating fibers of carpet and other floor coverings. In one aspect, the present invention provides compositions and methods that can reduce energy consumption and conserve water resources in the production of dyed fibrous substrates having desirable repellency and stain resistant properties.

### RELATED U.S. APPLICATION DATA

The present application claims priority under 35 U.S.C. §119(e) to U.S. Provisional Patent Application Ser. No. 61/102,233, filed Oct. 2, 2008, which is hereby incorporated by reference in its entirety.

### FIELD OF THE INVENTION

The present invention relates to compositions and methods for treating textile fibers and, in particular, to compositions and methods for treating fibers of carpet and other floor coverings.

### BACKGROUND OF THE INVENTION

Fibers of carpet and other floor coverings have long been dyed over a spectrum of colors to meet the requirements of various applications as well as consumer desires. In traditional processes, a dye is applied to carpet fibers or fibers of other floor coverings as a solution. Once applied, the dye and fibers are heated to sufficiently fix the dye to the fibers. Heating is usually effectuated by the application of steam. Subsequent to dye fixation, the carpet fibers are washed to remove fugitive tints, oils and other species residual from the dyeing process.

In many cases, it is desirable to apply oil repellent and/or stain resistant compositions to the dyed carpet fibers in order to increase the durability and useful life of the fibers. Oil repellent and/or stain resistant compositions are generally applied to dyed fibers in solution form. Once applied, the oil repellent and/or stain resistant compositions along with the fibers are heated to sufficiently fix the oil repellent and/or stain resistant compositions to the fibers. Similar to the dyeing process, heat is usually applied as steam. The treated carpet fibers are subsequently washed to remove chemical species residual to the treating process and extracted to remove excess wash water.

The foregoing two-cycle process of dyeing carpet fibers independent of treating the fibers with oil repellent and stain resistant compositions to produce a dyed and oil repellent and/or stain resistant carpet fiber compositions can result in the significant energy and water consumption. As provided above, each cycle of the two-cycle process requires the use of steam for fixation. Water has a high specific heat thereby necessitating the input of significant amounts of energy to produce the requisite steam. Moreover, additional water is consumed in the washing steps following dyeing and the application of oil repellent and/or stain resistant compositions. Furthermore, electrical energy is consumed across each cycle, with emphasis on the electrical energy required to perform two extractions of the carpet fibers subsequent to washing.

### SUMMARY

In view of the foregoing considerations, it would be desirable to provide compositions and methods for treating textile fibers, which can reduce energy and water consumption thereby lessening the overall environmental footprint of fiber treating processes.

The present invention provides compositions and methods for treating textile fibers including clothing and other garments and as well as fibers of carpet and other floor coverings which can reduce energy and water consumption.

In one aspect, the present invention provides an aqueous composition for treating a fibrous substrate, such as fibers of carpet or other floor coverings, comprising a dye component and at least one fluorochemical. In some embodiments, the dye component comprises at least one acid dye, cationic dye, dispersed dye, sulfur dye, vat dye, fiber reactive dye or mixtures thereof. In some embodiments, at least one fluorochemical comprises at least one fluorinated or perfluorinated chemical species including, but not limited to, fluorinated organic compounds and/or fluorinated monomers, oligomers and/or polymeric species. The aqueous composition, in some embodiments, further comprises a stain resistant chemical species.

In another aspect, the present invention provides a fibrous substrate comprising at least one fiber treated with an aqueous composition, the aqueous composition comprising a dye component and at least one fluorochemical. In some embodiments, the dye component comprises at least one acid dye, cationic dye, dispersed dye, sulfur dye, vat dye, fiber reactive dye or mixtures thereof. In some embodiments, at least one fluorochemical comprises at least one fluorinated or perfluorinated chemical species. Moreover, in one embodiment, the fibrous substrate comprises synthetic fibers. In another embodiment, the fibrous substrate comprises natural fibers.

In a further aspect, the present invention provides methods of making an aqueous composition for treating a fibrous substrate comprising providing an aqueous medium, disposing a dye component in the aqueous medium and disposing at least one fluorochemical in the aqueous medium. In some embodiments, methods of making an aqueous composition further comprises disposing a stain resistant chemical species in the aqueous medium.

In another aspect, the present invention provides a method of treating a fibrous substrate comprising providing an aqueous composition comprising a dye component and at least one fluorochemical, applying the aqueous composition to at least one fiber of the fibrous substrate. In some embodiments, the dye component comprises at least one acid dye, cationic dye, dispersed dye, sulfur dye, vat dye, fiber reactive dye or mixtures thereof. In some embodiments, at least one fluorochemical comprises at least one fluorinated or perfluorinated chemical species. In some embodiments, the fibrous substrate is heated. Moreover, in one embodiment, the fibrous substrate comprises synthetic fibers. In some embodiments, the fibrous substrate comprises a mixture of natural and synthetic fibers. In another embodiment, the fibrous substrate comprises natural fibers. In some embodiments, the fibrous substrate comprises a mixture of natural and synthetic fibers. In some embodiments, the aqueous composition applied to the fibrous substrate further comprises at least one stain resistant chemical species.

By comprising a dye component and at least one fluorochemical and optionally a stain resistant chemical species, aqueous compositions and methods of using aqueous compositions of the present invention, in some embodiments, can impart the desired color, oil repellency and stain resistant characteristics to fibers of a fibrous substrate in a single application cycle or step, thereby reducing water and energy consumption.

These and other embodiments are described in greater detail in the detailed description which follows.

### DETAILED DESCRIPTION

The present invention provides compositions and methods for treating textile fibers and, in particular, fibers of carpet and other floor coverings. Compositions and methods of the present invention, in some embodiments, can reduce energy and water consumption associated with fiber treating processes. In some embodiments, compositions and methods of the present invention can reduce the water consumed in producing dyed and stain resistant/oil repellent carpet compositions by up to about 50%. Moreover, compositions and methods of the present invention, in some embodiments, can reduce the energy consumption associated with producing dyed and stain resistant/oil repellent carpet compositions by 30% or greater through the application of a dye, fluorochemical and optionally a stain resistant chemical species in a single application cycle or step.

In one aspect, the present invention provides an aqueous composition for treating a fibrous substrate, such as fibers of clothing, carpet or other floor coverings, comprising a dye component and at least one fluorochemical.

Turning now to components that can be included in aqueous compositions of the present invention, aqueous compositions of the present invention comprise a dye component. In one embodiment, a dye component comprises at least one acid dye, cationic dye, dispersed dye, sulfur dye, vat dye, fiber reactive dye or mixtures thereof. Dyes for dyeing fibers of the fibrous substrate can be selected according to several parameters, including the identity of the fibers. Acid dyes, cationic dyes, dispersed dyes, sulfur dyes, vat dyes and fiber reactive dyes are well known and can comprise any of the same known to one of skill in the art not inconsistent with the objectives of the present invention.

Acid dyes, in some embodiments, for example, comprise fused ring structures. In some embodiments, acid dyes comprise anthraquinone and derivatives thereof. In other embodiments, acid dyes comprise azo dyes and derivatives thereof. In a further embodiment, acid dyes comprise triphenylmethane and related chemical structures. Moreover, in some embodiments, cationic dyes comprise basic dyes.

Acid dyes, cationic dyes, dispersed dyes, sulfur dyes, vat dyes and/or fiber reactive dyes for use in aqueous compositions of the present invention, in some embodiments, are commercially available from Clariant Corporation of Charlotte, N.C., Dystar L.P. of Charlotte, N.C. and Huntsman Corporation of Charlotte, N.C.

Aqueous compositions of the present invention can comprise any amount of dye component required to effectuate the desired dyed result on fibers of the fibrous substrate. In some embodiments, aqueous compositions of the present invention comprise varying amounts of dyes of different colors which are combined to produce the desired color. The 1931 or 1976 CIE chromaticity scale can be used as a reference, in some embodiments, when combining various dyes to produce a desired color.

In addition to a dye component, compositions of the present invention comprise at least one fluorochemical. In some embodiments, the at least one fluorochemical comprises a fluorinated or perfluorinated chemical species. In some embodiments, fluorinated and/or perfluorinated chemical species comprise fluorinated or perfluorinated organic compounds. Fluorinated or perfluorinated organic compounds, in some embodiments, comprise fluorinated monomers, fluorinated oligomers, fluorinated polymers or combinations thereof. In some embodiments, the at least one fluorochemical comprises one or a plurality of fluoropolymers.

In one embodiment, fluoropolymers suitable for use in aqueous compositions of the present invention comprise polymeric species having C₄ to C₂₀ fluorinated or perfluorinated chains. In another embodiment, fluoropolymers comprise a polymeric species having C₆ perfluorinated chains. In some embodiments, fluoropolymers comprise polymeric species having fluorinated or perfluorinated chains greater than C₂₀. In some embodiments, fluoropolymers having perfluorinated chains are produced from monomers of Formula (I):

R_{f}—(CH₂)ₙ—P (I)

wherein P is a polymerizable moiety, R_{f} is a straight chained or branched perfluoroalkyl group and n is an integer from 0 to 3. In some embodiments, R_{f} comprises a C₄ to C₂₀ perfluorinated alkyl group. In other embodiments, R_{f} comprises a fluorinated or perfluorinated alkyl group of at least C₂₀. In some embodiments, P comprises a site of unsaturation operable to undergo radical polymerization. In one embodiment, for example, P comprises an vinyl functionality, allyl functionality, acrylic functionality or methacrylic functionality. In other embodiments, P comprises a functionality operable to undergo condensation polymerization.

In some embodiments, fluoropolymers comprise fluoroalkyl methacrylates, fluoroalkyl acrylates, fluoroalkyl aryl urethanes, aliphatic fluoroalkyl urethanes, fluoroalkyl allyl urethanes, fluoroalkyl urethane acrylates, fluoroalkyl acrylamides, fluoroalkyl sulfonamide acrylates, fluoroalkyl sulfonamide methacrylates, fluoroalkyl sulfonamide urethanes, fluoroalkylesters, fluoroesters or fluoroethers or mixtures thereof. In other embodiments, fluoropolymers comprise polytetrafluoroethylene (PTFE), fluorinated ethylene-propylene (FEP), perfluoroalkoxy resin (PFA), polychlorotrifluoroethylene (PCTFE), ethylene-tetrafluoroethylene (EPTFE), polyvinylidene fluoride (PVDF), or polyvinyl fluoride (PVF) or mixtures thereof. In some embodiments, the fluoropolymers are crosslinked.

Fluoropolymers, in some embodiments of aqueous compositions of the present invention, comprise a dispersion or emulsion comprising a plurality of fluoropolymer particles dispersed throughout the aqueous composition. In one embodiment, fluoropolymer particles have an average size ranging from about 1 nm to about 500 nm. In another embodiment, fluoropolymer particles have an average size ranging from about 100 nm to about 400 or from about 200 nm to about 300 nm. In some embodiments, fluoropolymer particles have an average size ranging from about 10 nm to about 90 nm, from about 20 nm to about 60, or from about 30 nm to about 50 nm. In a further embodiment, fluoropolymer particles have an average size less than about 1 nm or greater than about 500 nm.

Fluoropolymer particles, in some embodiments, comprise any of the fluoropolymer species recited herein, including fluoropolymers having C₄ to C₂₀ or C₆ or greater than C₂₀ fluorinated or perfluorinated alkyl chains. In some embodiments, suitable fluoropolymers have a molecular weight ranging from about 100 to about 1,000,000. In some embodiments, fluoropolymer particles are dispersed throughout the continuous aqueous phase resulting in a colloid. Moreover, in some embodiments, fluoropolymers are anionic, cationic or non-ionic. Anionic and/or cationic charges, in some embodiments, can be imparted to fluoropolymers through the incorporation of monomers having anionic and/or cationic moieties.

In some embodiments, the at least one fluorochemical is present in an aqueous composition described herein at a concentration ranging from about 0.01 g/L to about 100 g/L. In another embodiment, the at least one fluorochemical is present in the aqueous composition at a concentration ranging from about 0.1 g/L to about 50 g/L or from about 0.5 g/L to about 20 g/L. In some embodiments, the at least one fluorochemical is present in the aqueous composition at a concentration ranging from about 1 g/L to about 10 g/L. In a further embodiment, the at least one fluorochemical is present in the aqueous composition at a concentration less than about 0.01 g/L or at a concentration greater than 100 g/L.

Fluorochemicals, including fluoropolymers, of aqueous compositions described herein are highly exhaustible onto fibers of a fibrous substrate and, in some embodiments, achieve exhaustion levels of about 50% to about 100% theoretical, thereby providing fibers increased resistance to stains, including oil and soil stains. In some embodiments, fluorochemicals, including fluoropolymers, of aqueous compositions described herein achieve exhaustion levels of at least about 80% or at least about 90% theoretical.

In addition to a dye component and at least one fluorochemical, aqueous compositions of the present invention, in some embodiments, further comprise an acid component. An acid component, in some embodiments, lowers the pH of aqueous compositions of the present invention.

In some embodiments, the acid component can comprise any chemical species operable to lower the pH of the aqueous composition, including inorganic acids and organic acids. In another embodiment, the acid component comprises a urea salt. A urea salt, in some embodiments, comprises urea sulfate, urea phosphate, urea hydrochloride or urea formate or mixtures thereof.

In some embodiments, the acid component is present in an aqueous composition of the present invention at a concentration ranging from about 0.1 g/L to about 30 g/L. In another embodiment, the acid component is present at a concentration ranging from about 0.5 g/L to about 20 g/L. In an further embodiment, the acid component is present at a concentration ranging from about 1 g/L to about 10 g/L. In one embodiment, the acid component is present at a concentration less than about 0.1 g/L or greater than about 20 g/L.

An aqueous composition comprising a dye component, at least one fluorochemical and optionally an acid component, in some embodiments, has a pH less than about 7.0. In some embodiments, an aqueous composition of the present invention has a pH less than about 5.5 or about 3.5. In another embodiment, an aqueous composition comprising a dye component, at least one fluorochemical and optionally an acid component has a pH less than about 2. In some embodiments, an aqueous composition of the present invention has a pH ranging from about 1 to about 2. In one embodiment, an aqueous composition has a pH less than about 1 or greater than about 7.0

In addition to a dye component and at least one fluorochemical, aqueous compositions of the present invention, in some embodiments, further comprise a stain resistant chemical species. Stain resistant chemical species are well known and, in some embodiments, stain resistant chemical species suitable for use in aqueous compositions of the present invention comprise any of the same known to one of skill in the art.

In some embodiments, a stain resistant chemical species comprises a sulfonated aromatic composition, including sulfonated aromatic condensation polymers. In some embodiments, a stain resistant chemical species comprises a sulfonated aromatic composition blended or copolymerized with an acrylic composition such as a polyacrylic acid, polymethacrylic acid, polymethylmethacrylate or combinations thereof. In some embodiments, a stain resistant chemical species comprises any one of the same described in U.S. Pat. Nos. 4,940,757 and 6,524,492 which are hereby incorporated by reference in their entirety. In another embodiment, a stain resistant chemical species comprises a styrene-maleic anhydride copolymer. In some embodiments, a styrene-maleic anhydride copolymer is blended or polymerized with a sulfonated aromatic composition. In some embodiments, a stain resistant chemical species comprises one or more aromatic phenol formaldehyde condensation polymers. A stain resistant chemical species, in some embodiments, comprises sulfonated novolac polymers.

In some embodiments, a stain resistant chemical species comprises a compound of Formula II:

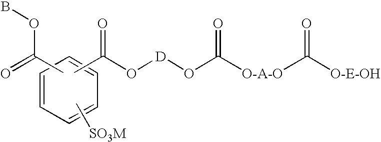

wherein A is an unsaturated alkylene moiety; B is the residue of a substituted or unsubstituted polyol wherein one hydroxyl moiety is esterified with one carboxyl moiety of the phthalic acid moiety; D is the residue of a substituted or unsubstituted polyol wherein one hydroxyl moiety is esterified with another carboxyl moiety of the phthalic acid moiety, and another hydroxyl moiety is esterified with one carboxyl moiety of the unsaturated alkylene moiety; E is the residue of a substituted or unsubstituted polyol wherein one hydroxyl moiety is esterified with another carboxyl moiety of the unsaturated alkylene moiety; and M is a cation.

In another embodiment, a stain resistant chemical species comprises a compound of Formula III:

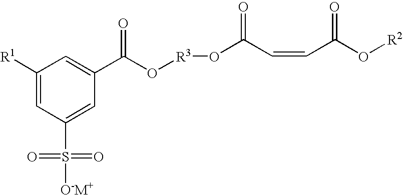

wherein R¹ is selected from the group consisting of -alkyl-C(O)OH, -cycloalkyl-C(O)OH, -alkenyl-C(O)OH and —C(O)OH and wherein R² is selected from the group consisting of -hydrogen, -alkyl-OH, -cycloalkyl-OH and -alkenyl-OH and wherein R³ is selected from the group consisting of alkyl, cycloalkyl and alkenyl and wherein M⁺ is a cationic species selected from the group of alkali metals.

In some embodiments, a stain resistant chemical species comprises a compound of Formula IV:

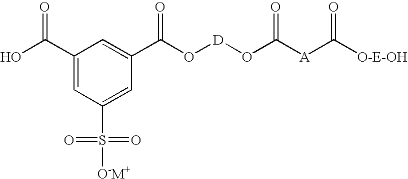

wherein A, D, E and M⁺ are defined hereinabove.

In some embodiments, a stain resistant chemical species comprises a polyester comprising one or more monomers of Formula II, Formula III and/or Formula IV. In one embodiment, for example, a stain resistant chemical species comprises a polyester of Formula V:

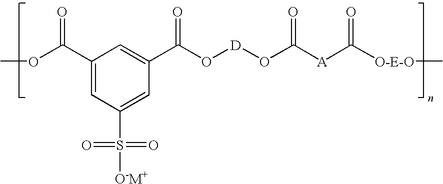

wherein A, D, E and M⁺ are defined hereinabove and n is at least 3. In some embodiments, a polymer of Formula V can be grafted with additional allylic and/or vinylic monomer including, but not limited to, acrylic and/or methacrylic monomer. Compounds of Formula II, Formula III and/or Formula IV are described in greater detail in U.S. Pat. No. 6,860,905 which is incorporated by reference herein in its entirety.

In some embodiments, a stain resistant chemical species is present in an aqueous composition of the present invention at a concentration ranging from about 0.01 g/L to about 100 g/L. In another embodiment, a stain resistant chemical species is present in the aqueous composition at a concentration ranging from about 0.1 g/L to about 50 g/L or from about 0.5 g/L to about 20 g/L. In some embodiments, a stain resistant chemical species is present in the aqueous composition at a concentration ranging from about 1 g/L to about 10 g/L. In a further embodiment, a stain resistant chemical species is present in the aqueous composition at a concentration less than about 0.01 g/L or at a concentration greater than 100 g/L.

In some embodiments, an aqueous composition of the present invention comprises a dye leveler component. A dye leveler component, in some embodiments, comprises one or more dye leveling compounds. Dye leveling compounds can be selected according to several factors including the identity of the dye(s) in the aqueous composition and the identity of the fibrous substrate to be treated with the aqueous composition. Any desired dye leveler compounds not inconsistent with the objectives of the present invention can be used.

In some embodiments, for example, a dye leveler component comprises dodecyl benzenesulfonic acid (DDBSA), non-ionic ethoxylated fatty alcohols, non-ionic ethoxylate fatty amines, naphthalene sulfonic acid sodium salts, sodium dioctyl sulfosuccinate or combinations thereof.

In another aspect, the present invention provides a fibrous substrate comprising at least one fiber treated with an aqueous composition, the aqueous composition comprising a dye component and at least one fluorochemical as described herein. In some embodiments, the aqueous composition further comprises an acid component operable to lower the pH of the aqueous composition. In some embodiments, the aqueous composition further comprises a stain resistant chemical species and/or dye leveler as provided herein.

A fibrous substrate comprising at least one fiber, in some embodiments, comprises any textile material including carpet, other floor covering types, upholstery and clothing. In some embodiments, fibers of the fibrous substrate comprise synthetic fibers. Synthetic fibers, in some embodiments, comprise nylon (polyamide) fibers, polyester fibers such as polytrimethylene terephthalate (PTT), polyethylene terephthalate (PET), polybutylene terephthalate (PBT), polyolefin fibers, polyurethane fibers, polyacrylonitrile fibers, polyacetate fibers or combinations thereof. In some embodiments, polyamide fibers comprise nylon 6, nylon 6/6, nylon 6/10 or nylon 6/12. In some embodiments, polyolefin fibers comprise polyethylene fibers, polypropylene fiber, polybutylene fibers or combinations thereof.

In some embodiments, a fibrous substrate comprising fibers treated with an aqueous composition of the present invention comprising a dye component and at least one fluorochemical has an oil repellency of at least 5 according to the American Association of Textile Chemists and Colorists (AATCC) Test Method 118. In other embodiments, a fibrous substrate comprising fibers treated with an aqueous composition of the present invention has an oil repellency of at least 6 according to AATCC 118. In a further embodiment, a fibrous substrate comprising fibers treated with an aqueous composition of the present invention has an oil repellency of at least 7 according to AATCC 118.

Moreover, in some embodiments, a fibrous substrate comprising fibers treated with an aqueous composition of the present invention comprising a dye component at least one fluorochemical has a water/alcohol repellency according to AATCC Test Method 193 of at least 5. In another embodiment, a fibrous substrate comprising fibers treated with an aqueous composition of the present invention has a water/alcohol repellency of at least 6 or at least 7 according to AATCC 193. In a some embodiments, a fibrous substrate comprising fibers treated with an aqueous composition of the present invention has a water/alcohol repellency of at least 8 according to AATCC 193.

In addition to demonstrating advantageous repellencies under AATCC test methods, fibrous substrates comprising fibers treated with aqueous compositions of the present invention comprising a dye component and at least one fluorochemical also demonstrate advantageous repellencies according to testing with the compositions provided in Table I and Table II. The compositions of Table I comprise various hydrocarbons while the compositions of Table II comprise various water/isopropyl alcohol (IPA) solutions. Testing with the compositions of Tables I and II is administered in accordance with the procedures set forth in AATCC 118 and 193. The repellency of the substrate to the applied liquid, for example, is measured after 30 seconds for oil (Table I compositions) or 10 seconds for a water/isopropyl alcohol solution (IPA) (Table II compositions). A score is assigned based on the highest number of liquid repelled according to Tables I and II.

TABLE I
Oil Test Solutions

| Oil Repellency Rating | Test Solution Composition |
|---|---|
| 1 | Nujol/Kadol |
| 2 | 65/35 Nujol/n-hexadecane by volume @ 70° F. |
| 3 | n-hexadecane |
| 4 | n-tetradecane |
| 5 | n-dodecane |
| 6 | n-decane |
| 7 | n-octane |
| 8 | n-heptane |

TABLE II
Water/IPA Test Solutions

| Water/IPA Repellency Rating | Test Solution Composition (vol:vol) | |
|---|---|---|
| 1 | Water | |
| 2 | 98:2 | Water/IPA |
| 3 | 95:5 | Water/IPA |
| 4 | 90:10 | Water/IPA |
| 5 | 80:20 | Water/IPA |
| 6 | 70:30 | Water/IPA |
| 7 | 60:40 | Water/IPA |
| 8 | 50:50 | Water/IPA |
| 9 | 30:70 | Water/IPA |
| 10 | 20:80 | Water/IPA |
| 11 | 10:90 | Water/IPA |
| 12 | 100 | IPA |

In some embodiments, a fibrous substrate comprising fibers treated with an aqueous composition of the present invention comprising a dye component and at least one fluorochemical has an oil repellency of at least 5 according to the Table I. In another embodiment, a fibrous substrate comprising fibers treated with an aqueous composition of the present invention has an oil repellency of at least 6 or at least 7 according to Table I.

Moreover, in some embodiments, a fibrous substrate comprising fibers treated with an aqueous composition of the present invention comprising a dye component and at least one fluorochemical has a water/IPA repellency according to Table II of at least 5 or at least 6. In another embodiment, a fibrous substrate comprising fibers treated with an aqueous composition of the present invention has a water/IPA repellency of at least 7 or at least 8 according to Table II. In a further embodiment, a fibrous substrate comprising fibers treated with an aqueous composition of the present invention has a water/IPA repellency of at least 9 according to Table II.

In addition to oil repellencies, fibrous substrates comprising fibers treated with an aqueous composition of the present invention demonstrate advantageous stain resistance. Staining of a fibrous substrate can be measured against the standard grey scale set forth in AATCC Test Method 130. The grey scale of AATCC 130 ranges from 1 to 5 wherein a rating of 1 represents a dark residual stain and a rating of 5 represents no residual stain.

In some embodiments, a fibrous substrate comprising fibers treated with an aqueous composition of the present invention comprising a dye component, at least one fluorochemical and optionally a stain resistant chemical species has a stain rating of at least 4 on the grey scale of AATCC 130. In another embodiment, a fibrous substrate comprising fibers treated with an aqueous composition of the present invention comprising a dye component, at least one fluorochemical and optionally a stain resistant chemical species has a stain rating of 5 on the grey scale of AATCC 130.

By comprising a dye component, at least one fluorochemical and optionally a stain resistant chemical species, aqueous compositions of the present invention, in some embodiments, are operable to impart the desired color, oil repellency and stain resistant characteristics to fibers of a fibrous substrate in a single application cycle or step. As described herein, prior to the present invention, an application of two independent compositions in two independent cycles was necessary to achieve a fibrous substrate having the desired color, oil repellency and stain resistant characteristics. Prior compositions and methods required application of a dye component in a first cycle followed by application of a fluorochemical and/or stain resistant compound in a second cycle.

Compositions and methods of the present invention, in some embodiments, preclude the requirement to apply dye and fluoropolymer compositions in separate cycles thereby realizing significant energy savings in addition to the conservation of water.

In another aspect, the present invention provides methods of making an aqueous composition for treating fibers of a fibrous substrate comprising providing an aqueous medium, disposing a dye component in the aqueous medium and disposing at least one fluorochemical in the aqueous medium. In some embodiments, the dye component and the at least one fluorochemical are each disposed in the aqueous medium in preparation of a batch for application to fibers of a fibrous substrate. In other embodiments, at least one of the dye component and the fluorochemical is disposed in the aqueous medium immediately prior to application to fibers of a fibrous substrate, such as in a in-line process. Dye components and fluorochemicals suitable for use in methods of making aqueous compositions of the present invention can comprise any of the same described herein.

In some embodiments, the at least one fluorochemical is provided to the aqueous medium as an aqueous dispersion or emulsion of fluoropolymer particles. The fluoropolymer particles, in some embodiments, have sizes consistent with any of the particle sized described herein.

In some embodiments, methods of making an aqueous composition of the present invention further comprise disposing an acid component in the aqueous medium. Acid components suitable for use in methods of the present invention can comprise any of the same described herein. Moreover, in some embodiments, methods of making an aqueous composition of the present invention further comprises disposing a stain resistant chemical species in the aqueous medium. Stain resistant chemical species suitable for use in methods of the present invention can comprise any of the same described herein.

In some embodiments, an aqueous composition is prepared in batch form. In other embodiments, an aqueous composition is prepared in an in-line process wherein the dye component or the at least one fluorochemical is disposed in the aqueous medium immediately prior to application of the aqueous composition to a fibrous substrate. In one embodiment, for example, the at least one fluorochemical is injected into the aqueous medium already comprising a dye component as the aqueous medium is transported through apparatus for application to a fibrous substrate. In another embodiment, the dye component is injected into the aqueous medium already comprising at least one fluorochemical as the aqueous medium is transported through apparatus for application to a fibrous substrate.

In another aspect, the present invention provides a method of treating a fibrous substrate comprising providing an aqueous composition comprising a dye component and at least one fluorochemical, applying the aqueous composition to at least one fiber of the fibrous substrate and heating the fibrous substrate. Dye components and fluorochemicals suitable for use in methods of treating a fibrous substrate, in some embodiments, comprise any of the same described herein.

In some embodiments, applying an aqueous composition of the present invention to at least one fiber of the fibrous substrate comprises spray coating, dip coating, passing the fibrous substrate through kiss rollers, or spreading onto or coating the at least one fiber though a head box, optionally with the aid of a doctor blade.

Moreover, in some embodiments, the fibrous substrate is heated to a temperature ranging from about 40° C. to about 150° C. after application of the aqueous composition comprising a dye component and at least one fluorochemical. In other embodiments, the fibrous substrate is heated to a temperature ranging from about 50° C. to about 135° C. or from about 60° C. to about 90° C. In another embodiment, the fibrous substrate is heated to a temperature ranging from about 65° C. to about 80° C. In one embodiment, the fibrous substrate is heated by steam subsequent to the application of an aqueous composition of the present invention.

The fibrous substrate can be heated by any desired method not inconsistent with the objectives of the present invention. In some embodiments, for example, textiles including carpets and other floor coverings, are heated in a atmospheric steamer or a pressure dye beck subsequent to receiving an aqueous composition of the present invention. In other embodiments, fibrous substrates are heated by the application of a heated fluid including, but not limited to, heated air and/or other gas, heated water and/or steam.

In some embodiments, the treated fibrous substrate is heated for a time period ranging from about 10 seconds to about 10 minutes. In other embodiments, the treated fibrous substrate is heated for a time period ranging from about 30 seconds to about 5 minutes or from about 1 minute to about 3 minutes. In another embodiment, the treated fibrous substrate is heated for a time period ranging from about 1 minute to about 2 minutes or from about 1 minute to about 90 seconds. In further embodiment, the treated fibrous substrate is heated for a time period less than about 30 seconds or greater than about 10 minutes.

Moreover, in some embodiments of methods of treating a fibrous substrate, the aqueous composition is heated prior to application to fibers of a fibrous substrate. In some embodiments, the aqueous composition is heated to a temperature of at least 50° C. In another embodiment, the aqueous composition is heated to a temperature ranging from about 90° C. to about 100° C.

In some embodiments, methods of treating a fibrous substrate further comprise washing the fibrous substrate subsequent to heating the fibrous substrate. Washing the fibrous substrate subsequent to heating, in some embodiments, removes chemical species residual from the aqueous composition. Furthermore, in some embodiments, the fibrous substrate is extracted to remove wash water prior to drying. Fibrous substrates treated with an aqueous composition described herein, in some embodiments, are subjected to further treatments or subsequent processing steps.

Aqueous compositions for use in methods of treating fibrous substrates, in some embodiments, further comprise an acid component. In some embodiments, acid components suitable for use in aqueous compositions of the present invention comprise any of the same recited herein. Moreover, in some embodiments, aqueous compositions for use in methods of treating fibrous substrates further comprise a stain resistant chemical species and/or dye leveling species. Stain resistant and dye leveling chemical species suitable for use in methods of the present invention, in some embodiment, comprise any of the same described herein.

A fibrous substrate comprising at least one fiber, in some embodiments of methods of the present invention, comprises any textile material including carpet, other floor covering types, upholstery and clothing. In some embodiments, fibers of the fibrous substrate comprise synthetic fibers. Synthetic fibers, in some embodiments, comprise nylon (polyamide) fibers, polyester fibers such as polytrimethylene terephthalate (PTT), polyethylene terephthalate (PET), polybutylene terephthalate (PBT), polyolefin fibers, polyurethane fibers, polyacrylonitrile fibers, polyacetate fibers or combinations thereof. In some embodiments, polyamide fibers comprise nylon 6, nylon 6/6, nylon 6/10 or nylon 6/12. In some embodiments, polyolefin fibers comprise polyethylene fibers, polypropylene fiber, polybutylene fibers or combinations thereof.

As provided herein, methods of the present invention, in some embodiments, produce fibrous articles, such as carpet, other floor coverings or clothing, having the desired color, repellency and stain resistant characteristics in a single step or cycle. Prior methods require application and fixation of a dye component to the fibrous article in a first step or cycle followed by application and fixation of a fluorochemical and/or stain resistant composition in a second step or cycle. According to the present invention, it has been surprisingly found that fluorochemicals can be simultaneously applied and fixed to fibers with a dye component resulting in fibrous articles having the desired color and advantageous repellency and stain resistant properties. Compositions and methods of the present invention can, therefore, eliminate the second step or cycle thereby realizing significant energy savings in addition to the conservation of water.

Embodiments of the present invention are further illustrated in the following non-limiting examples.

### Example 1

### Application of an Aqueous Composition to a Fibrous Substrate

An aqueous composition of the present invention was prepared for application to nylon 6 carpet fibers by adding to a mixing tank 10 g of a C₆ acrylate fluoropolymer dispersion available from Peach State Labs of Rome, Ga. as Sartech 13-60 per liter of distilled water in the mixing tank. 18.75 g of a polyester stain resistant chemical species available from Peach State Labs as Myalon SBLC were also added per liter of distilled water in the mixing tank. A sufficient amount of urea sulfate was added to the aqueous composition comprising the acrylate fluoropolymer and polyester stain resistant chemical species to bring the pH of the aqueous composition to 1.9.

The aqueous composition was subsequently injected with a sufficient amount of light tan acid dye in route to application to the nylon 6 carpet fibers by a Kuster type Fluidyer at 400% wet pick up. The treated nylon 6 carpet was subsequently steamed for about 3.5 minutes in a vertical steamer with saturated steam, rinse extracted and dried.

### Example 2

### Application of an Aqueous Composition to a Fibrous Substrate

An aqueous composition of the present invention was prepared for application to nylon 6 carpet fibers by adding to a mixing tank 5.6 g of a C₆ acrylate fluoropolymer dispersion available from Peach State Labs of Rome, Ga. as Sartech 13-60 per liter of distilled water in the mixing tank. 13.3 g of a polyester stain resistant chemical species available from Peach State Labs as Myalon SBLC were also added per liter of distilled water in the mixing tank. 5.1 g of urea sulfate per liter of distilled water in the mixing tank were added to the aqueous composition comprising the acrylate fluoropolymer and polyester stain resistant chemical species to bring the pH of the aqueous composition to 1.68.

The aqueous composition was subsequently injected with a sufficient amount of light tan acid dye in route to application to the nylon 6 carpet fibers by a Kuster type Fluidyer at 450% wet pick up. The treated nylon 6 carpet was subsequently steamed for about 3.5 minutes in a vertical steamer with saturated steam, rinse extracted and dried.

### Example 3

### Oil Repellency and Stain Resistance Testing of Examples 1 and 2

The treated nylon 6 carpet compositions were tested for repellency and stain resistance according to the following protocols. Repellency was measured by floating the treated carpet compositions of Examples 1 and 2 back side down in a Kool Aid (with sugar) solution at 75° F. for 5 minutes. A pass rating was assigned if the treated carpet sample floated with only fibers on the back of the sample contacting the solution. A marginal rating was assigned if the treated carpet sample sank in the solution up to half the fiber height on the face of the sample. A fail rating was assigned if the treated carpet sample sank in the solution prior to expiration of the 5 minutes.

Stain resistance was determined according to observations of residual Kool Aid stain (with sugar) made subsequent to applying a solution of Kool Aid (with sugar) at 140° F. to the treated nylon 6 carpet samples from a height of 1 foot and allowing the applied solution to sit on the carpet samples for 5 minutes followed by rinsing the carpet samples with cold tap water. A pass rating was assigned if no visible red staining was present. A marginal rating was assigned if visible red staining was present equating to a value of 3 to 4 according AATCC Stain Release Method 130. A fail rating was assigned if extreme red staining was visible equating to a value less than 3 according AATCC Stain Release Method 130.

Fluorochemical exhaustion onto fibers of the nylon 6 carpet samples of Examples 1 and 2 was additionally measured by a Schoeniger Flask Combustion and Fluoride ion probe.

Table III summarizes the results of the repellency and stain resistance testing of treated nylon 6 carpet samples produced according to Examples 1 and 2. Table III also provides the results of fluorochemical exhaustion testing.

TABLE III
Treated Nylon 6 Carpet Samples Testing Results

| | | | | Fluorochemical |
|---|---|---|---|---|
| Example | Repellency | Stain Resist | Dyeing | Exhaustion |
| 1 | Marginal | Pass | Pass | 150-200 ppm |
| 2 | Pass | Pass | Pass | 380-390 ppm |

As provided in Table III, the nylon 6 carpet samples of Examples 1 and 2 treated with aqueous compositions of the present invention and in accordance with methods of the present invention demonstrated satisfactory repellency, stain resist, dyeing and fluorochemical exhaustion properties. As a result, compositions and methods of the present invention can eliminate steps in current processes for obtaining dyed fiber compositions having advantageous repellency and stain resist properties, thereby realizing significant energy savings in addition to water conservation.

Various embodiments of the invention have been described in fulfillment of the various objectives of the invention. It should be recognized that these embodiments are merely illustrative of the principles of the present invention. Numerous modifications and adaptations thereof will be readily apparent to those of skill in the art without departing from the spirit and scope of the invention.

That which is claimed is:

1. An aqueous composition for treating a fibrous substrate comprising:
a dye component; and
at least one fluorochemical.

2. The aqueous composition of claim 1, wherein the dye component comprises at least one acid dye, cationic dye, dispersed dye, vat dye or fiber reactive dye or mixtures thereof.

3. The aqueous composition of claim 1, wherein the at least one fluorochemical comprises a fluorinated organic compound.

4. The aqueous composition of claim 1, wherein the fluorinated organic compound comprises a fluoromonomer, fluorinated oligomer, fluoropolymer or mixtures thereof.

5. The aqueous composition of claim 4, wherein the at least one fluorochemical comprises a plurality of fluoropolymers.

6. The aqueous composition of claim 4, wherein the fluorinated organic compound is present in the aqueous composition at a concentration ranging from about 0.01 g/L to about 100 g/L.

7. The aqueous composition of claim 1 further comprising an acid component.

8. The aqueous composition of claim 7, wherein the acid component comprises a urea salt.

9. The aqueous composition of claim 7 having a pH of less than about 3.5.

10. The aqueous composition of claim 8, wherein the urea salt is present at a concentration ranging from about 0.1 g/L to about 30 g/L.

11. The aqueous composition of claim 1 further comprising a stain resistant chemical species.

12. The aqueous composition of claim 11, wherein the stain resistant chemical species comprises one or more sulfonated aromatic condensation polymers.

13. The aqueous composition of claim 12, wherein the stain resistant chemical species is present at a concentration ranging from about 0.01 g/L to about 100 g/L.

14. A fibrous substrate comprising:
at least one fiber treated with an aqueous composition, the aqueous composition comprising a dye component and at least one fluorochemical.

15. The fibrous substrate of claim 14, wherein the dye component comprises at least one acid dye, cationic dye, dispersed dye, sulfur dye, vat dye or fiber reactive dye or mixtures thereof.

16. The aqueous composition of claim 14, wherein the at least one fluorochemical comprises a fluorinated organic compound.

17. The aqueous composition of claim 16, wherein the fluorinated organic compound comprises a fluoromonomer, fluorinated oligomer, fluoropolymer or mixtures thereof.

18. The aqueous composition of claim 14 further comprising a stain resistant chemical species.

19. A method of treating a fibrous substrate comprising:
providing an aqueous composition comprising a dye component and at least one fluorochemical; and
applying the aqueous composition to at least one fiber of the fibrous substrate.

20. The method of claim 19, wherein the dye component comprises at least one acid dye, cationic dye, dispersed dye, vat dye or fiber reactive dye or mixtures thereof.

21. The method of claim 19, wherein the at least one fluorochemical comprises a fluorinated organic compound.

22. The method of claim 21, wherein the fluorinated organic compound comprises a fluoromonomer, fluorinated oligomer, fluoropolymer or mixtures thereof.

23. The method of claim 22, wherein the at least one fluorochemical comprises a plurality of fluoropolymers.

24. The method of claim 22, wherein the fluorinated organic compound is present in the aqueous composition at a concentration ranging from about 0.01 g/L to about 100 g/L.

25. The method of claim 19, wherein the aqueous composition further comprises an acid component.

26. The method of claim 25, wherein the acid component comprises a urea salt.

27. The method of claim 25, wherein the aqueous composition has a pH of less than about 3.5.

28. The method of claim 19, wherein the aqueous composition further comprises a stain resistant chemical species.

29. The method of claim 28, wherein the stain resistant chemical species comprises one or more sulfonated aromatic condensation polymers.

30. The method of claim 19 further comprising heating the fibrous substrate.

31. The method of claim 22, wherein the fibrous substrate does not receive an additional application of the fluorinated organic compound separate from the dye component.

32. The method of claim 28, wherein the fibrous substrate does not receive an additional application of the stain resistant chemical species separate from the dye component.

33. The method of claim 22, wherein fibrous substrate has an oil repellency of at least 5 according to the American Association of Textile Chemists and Colorists (AATCC) Test Method 118 after treatment with the aqueous composition.

34. The method of claim 22, wherein fibrous substrate has an oil repellency of at least 7 according to the American Association of Textile Chemists and Colorists (AATCC) Test Method 118 after treatment with the aqueous composition.

35. The method of claim 22, wherein fibrous substrate has a water/alcohol repellency of at least 7 according to the AATCC Test Method 193 after treatment with the aqueous composition.

36. The method of claim 28, wherein fibrous substrate has a stain rating of at least 4 on the grey scale of AATCC Test Method 130 after treatment with the aqueous composition.
